(19) United States
(12) Patent Application Publication
(10) Pub. No.: US 2019/0266254 A1
(43) Pub. Date: Aug. 29, 2019

(54) SYSTEM TO PROCESS ELECTRONIC RECORDS USING A REQUEST ORCHESTRATION PLATFORM

(71) Applicants: Jeremy D. Blumenfeld, Canton, CT (US); Satish K Kasala, Avon, CT (US); Kristin Ann Lede, Natick, MA (US); Nathan M. Swaim, Manchester, CT (US); Philip Wawrzynowicz, Lebanon, CT (US)

(72) Inventors: Jeremy D. Blumenfeld, Canton, CT (US); Satish K Kasala, Avon, CT (US); Kristin Ann Lede, Natick, MA (US); Nathan M. Swaim, Manchester, CT (US); Philip Wawrzynowicz, Lebanon, CT (US)

(21) Appl. No.: 15/904,781

(22) Filed: Feb. 26, 2018

(51) Int. Cl. G06F 17/30; G06N 99/00; G06N 3/00; G06Q 40/08; G06F 17/27

(52) U.S. Cl. CPC G06F 17/3056; G06F 17/30595; G06N 99/005; G06F 17/2705; G06Q 40/08; G06F 17/278; G06F 17/2785; G06N 3/006

(57) ABSTRACT

According to some embodiments, an artificial intelligence orchestration platform may automatically determine an intent of an electronic record (e.g., an email message, text, translated voice channel request, etc.) associated with a request (e.g., by communicating with a classification platform service or analyzing the electronic record). Based on an indication of intent, an entity extraction platform may extract at least one requisite entity identifier from the electronic record in accordance with a transaction requirement. A robotic automation platform may then process the request utilizing the indication of intent and the extracted requisite entity identifier. For example, the robotic automation platform may transmit a complete response to the request, pre-populate data in a template provided to a human knowledge worker, determine additional information associated with the request, etc.

### BACKGROUND

An enterprise may need to respond to requests. For example, an insurance company might need to respond to customer requests for Certificates Of Insurance (“COI”), policy cancelations, etc. Note that these requests might be received via various channels, such as a telephone call, web form, email message, etc. Responding to these requests can be a time consuming and difficult task, especially when a substantial number of requests are received (e.g., an enterprise might receive thousands of requests on a daily basis). Moreover, different types of requests might require different types of processing (e.g., information validation, determining supplemental information, etc.). Determining how to properly respond to requests can also be a time consuming and error-prone process, especially there are many different types of requests that might need responses.

Thus, there is a need in the art for methods and systems to respond to requests in an efficient and accurate manner.

### SUMMARY OF THE INVENTION

According to some embodiments, systems, methods, apparatus, computer program code and means are provided to respond to requests in an efficient and accurate manner. According to some embodiments, an artificial intelligence orchestration platform may automatically determine an intent of an electronic record (e.g., an email message, text, translated voice channel request, etc.) associated with a request (e.g., by communicating with a classification platform service or analyzing the electronic record). Based on an indication of intent, an entity extraction platform may extract at least one requisite entity identifier from the electronic record in accordance with a transaction requirement. A robotic automation platform may then process the request utilizing the indication of intent and the extracted requisite entity identifier. For example, the robotic automation platform may transmit a complete response to the request, pre-populate data in a template provided to a human knowledge worker, determine additional information associated with the request, etc.

Some embodiments provide: means for automatically determining, by an artificial intelligence orchestration platform, an intent of an electronic record associated with a request; based on an indication of intent, means for extracting, by an entity extraction platform, at least one requisite entity identifier from the electronic record in accordance with a transaction requirement; and means for processing the request, by a robotic automation platform, utilizing the indication of intent and the extracted requisite entity identifier.

A technical effect of some embodiments of the invention is an improved and computerized way of responding to requests in an efficient and accurate manner. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 illustrates channels to respond to requests for certificates of insurance.

FIG. 2 is a use case for processing requests for certificates of insurance.

FIG. 3 is a customer service representative display that might be associated with a request for certificate of insurance.

FIG. 4 illustrates a channel to respond to requests for certificates of insurance in accordance with some embodiments.

FIG. 5 is a method that may be performed according to some embodiments.

FIG. 6 is a use case for processing requests for certificates of insurance in accordance with some embodiments.

FIG. 7 is a solution context that might be implemented according to some embodiments.

FIG. 8 is a solution context with expanded applicability in accordance with some embodiments.

FIG. 9 is a run-time implementation of an end-to-end approach according to some embodiments.

FIG. 10 is a design-time implementation of an end-to-end approach according to some embodiments.

FIG. 11 is high level overview of an end-to-end design in accordance with some embodiments.

FIGS. 12 and 13 is an orchestration workflow method according to some embodiments.

FIG. 14 is block diagram of a platform according to some embodiments of the present invention.

FIG. 15 illustrates a tabular portion of a request results database in accordance with some embodiments.

FIG. 16 is a high-level process flow according to some embodiments.

FIG. 17 is another high-level process flow in accordance with some embodiments.

FIG. 18 illustrates attachment processing according to some embodiments.

FIG. 19 illustrates a display in accordance with some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of electronic record analysis by providing benefits in data accuracy, data availability, and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third-party systems, networks, and subsystems. For example, in the present invention information may be transmitted to remote devices from an orchestration server and electronic records may be interpreted and routed as appropriate, thus improving the overall performance of the system associated with message storage requirements and/or bandwidth considerations (e.g., by reducing the number of messages that need to be transmitted via a network). Moreover, embodiments associated with automatic predictions might further improve communication network performance, user interactions, real time chat or telephone call center responsiveness (e.g., by better preparing and/or allocating resources), etc.

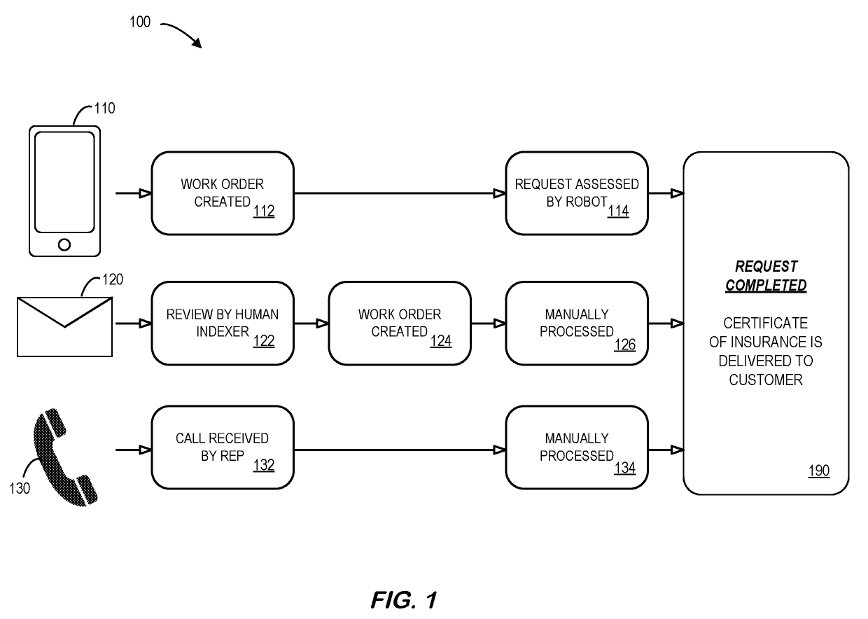

FIG. 1 illustrates channels 100 to respond to requests for certificates of insurance. In particular, a smartphone 110 or web interface may be used by a customer to provide a request for a COI to an insurance company (e.g., by having the customer fill out a template). Responsive to the request, a work order may be created 112 and the request may be assessed 114 by a “robot.” As used herein, the terms “robot” or “bot” may refer to any automated processing performed for an enterprise. As a result of the assessment 114, the request may be completed 190 and a COI may be delivered to the customer. Such a streamlined approach might, for example, cost less than $1.00 pre-request to process.

In other cases, an email message 120 might be reviewed by a human indexer 122 who will attempt to determine what the customer needs. The indexer can then manually create a work order 124 that is then manually processed 126 before the request is completed 190. Such an approach might, for example, cost $5.00 per-request to process. In still other cases, a phone call 130 might be received by a human customer service representative 132 who will manually process the request 134 to completion 190. Such an approach might, for example, cost $10.00 per-request to process.

Note that an enterprise may receive email, text, speech, etc. requests from customers for various reasons. For example, an insurance company might receive emails from customers regarding the purchase of new insurance policies, billing questions, inquiries about insurance claims, etc. Moreover, different service representatives may have different skills, abilities, domain expertise, etc. For example, one service representative might specialize in helping customers purchase new insurance policies while another service representative specializes in helping answering customer billing questions. Thus, a received email may need to be eventually routed to an appropriate queue to be serviced by a customer service representative.

In the approach of FIG. 1, an enterprise may use a first-tier service representative (a minimally trained representative) to triage a customer's needs based on a general understanding of insurance along with a decision making “if/then” matrix. Once the customer intent is manually established, the representative may locate some pertinent information within the text and paste that information into a business work form to better structure the data. The first-tier representative may then assign the work to a queue for higher skilled knowledge workers to fully process. In this case, a customer may need to wait hours or even weeks for a request to be fulfilled. This long lead time might be because of, for example, queue size and/or misclassified intent classification by the first-tier service representative.

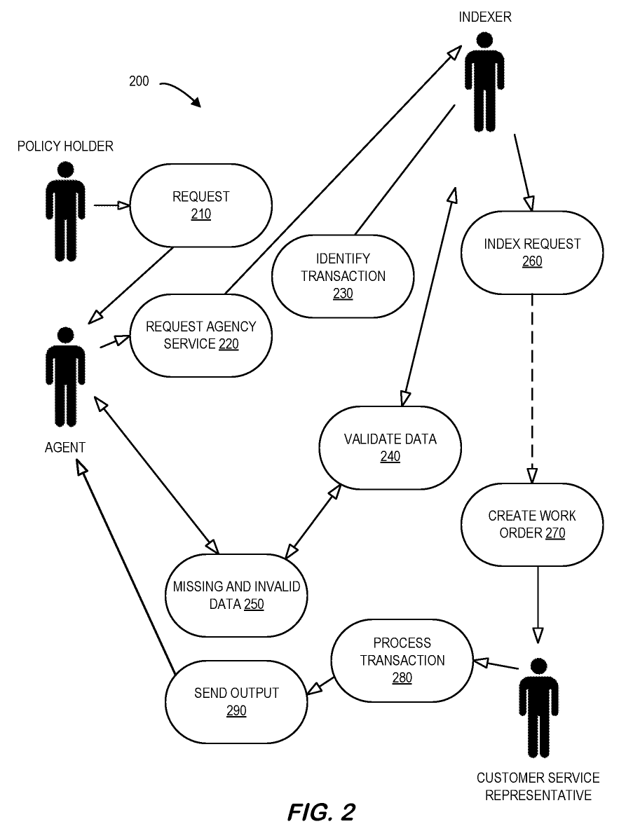

FIG. 2 is a use case 200 for processing requests for certificates of insurance. A policy holder or agent might generate a request 210 and/or request agency service 220. An indexer might respond to the request by identifying a type of transaction 230 and determining if a validate data 240 process indicates that missing or invalid data 250 needs to be supplied or corrected. The indexer can then index the request 260 to invoke a work order 270. A customer service representative may the process the transaction 280 and invoke a send output 290 process to complete the request.

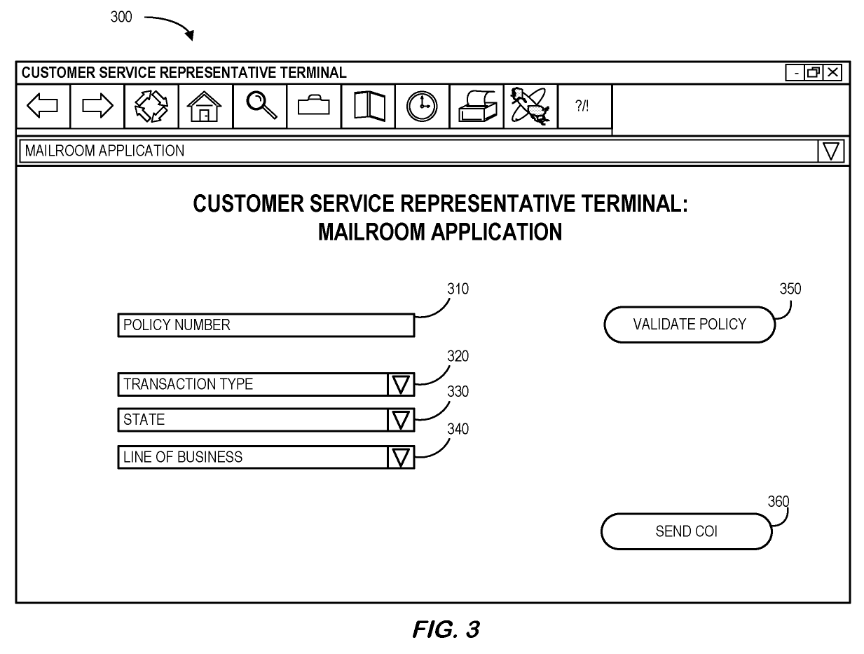

The indexer might use one or more displays to process the request. For example, FIG. 3 is a customer service representative display 300 that might be associated with a request for COI. The display 300 allows for the input of a policy number 310, transaction type 320, geographic location 330, and a line of business 340. The display 300 also includes selectable icons that can be used to validate an insurance policy 350 and/or to send a COI 360 to a customer.

Using such a display 300, however, can be a time consuming and error-prone process (e.g., an incorrect transaction type 320 might be selected). According to some embodiments described herein, systems, methods, apparatus, computer program code and means may provide a tool to facilitate the full end-to-end automated processing of email/text/voice channel requests. In some embodiments, an email is received. An orchestrator/flow manager may be accessed, from an artificial intelligence platform, to identify customer intent. It may then be arranged for requisite entities, identified by intent type, to be extracted in accordance with transaction requirements. Once the requisite data is acquired, a robotic automation may complete the request or pass along information to knowledge workers with portions of the data administration complete. In some cases, the robotic automation may reach out to customer, or other accessible backend systems, in an attempt to acquire missing information or to correct invalid data (e.g., a typographical error in a policy number).

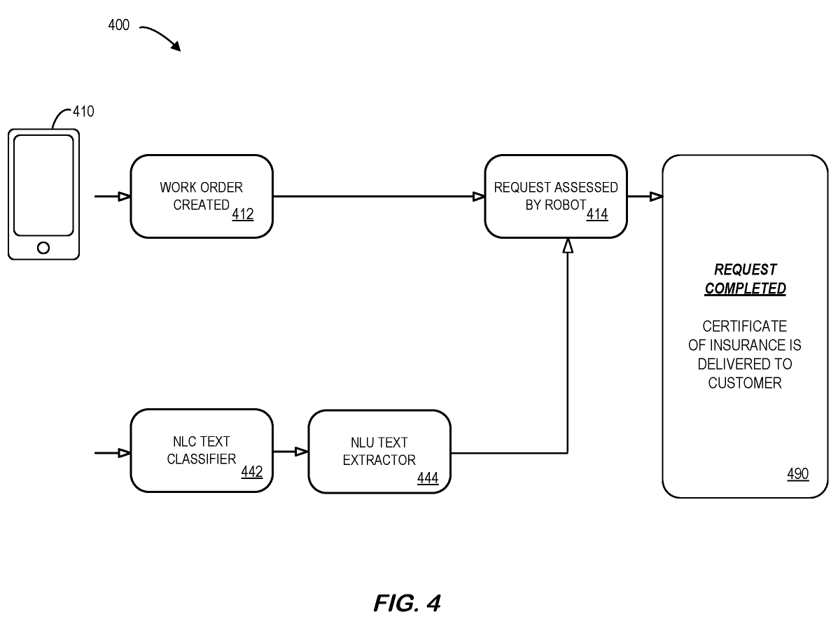

FIG. 4 is block diagram of a system 400 according to some embodiments of the present invention. As in FIG. 1, a smartphone 410 or web interface may be used by a customer to provide a request for a COI to an insurance company (e.g., by having the customer fill out a template). Responsive to the request, a work order may be created 412 and the request may be assessed 414 by a robot. As a result of the assessment 414, the request may be completed 490 and a COI may be delivered to the customer.

Note that the robot assessment 414 might require a structured intake of data. According to some embodiments described herein, Natural Language Process (“NLP”) may remove the need for human indexers and create structured intake data from free-form email requests. In particular, a Natural Language Classifier (“NLC”) service 442 may receive email, text message, translated voice input, etc. A Natural Language Understanding (“NLU”) text extraction process 444 may then locate the information needed by the robotic assessment 414 to complete the request 490.

The NLC 442 or NLU 444 might be, for example, associated with a cloud-based architecture, Personal Computer (“PC”), laptop computer, an enterprise server, a server farm, and/or a database or similar storage devices. The NLC 442 or NLU 444 may, according to some embodiments, be associated with a business organization or an insurance provider.

As used herein, devices, including those associated with the NLC 442 or NLU 444 and any other device described herein, may exchange information via any communication network which may be one or more of a telephone network, a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

According to some embodiments, an “automated” NLC 442 or NLU 444 may mine information from a request (e.g., text input data sources). As used herein, the term “automated” may refer to, for example, actions that can be performed with little or no human intervention. The NLC 442 or NLU 444 may store information into and/or retrieve information from databases. The databases may be a locally stored relational database or reside remote from the NLC 442 or NLU 444. The term “relational” may refer to, for example, a collection of data items organized as a set of formally described tables from which data can be accessed. Moreover, a Relational Database Management System (“RDBMS”) may be used in connection with any of the database tables described herein. According to some embodiments, a graphical administrator interface may provide an ability to access and/or modify the NLC 442 or NLU 444. The administrator interface might, for example, let an administrator define terms, dictionaries, mapping rules, etc. associated with text mining. Moreover, note that the NLC 442 or NLU 444 may operate asynchronously and/or independently of other insurance applications.

Although a single NLC 442 or NLU 444 is shown in FIG. 4, any number of such devices may be included. Moreover, various devices described herein might be combined according to embodiments of the present invention. For example, in some embodiments, the NLC 442 and NLU 444 might be co-located and/or may comprise a single apparatus.

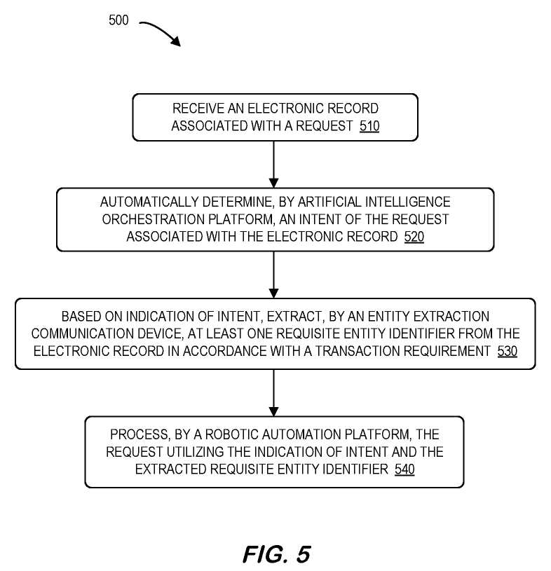

In this way, the system 400 may facilitate an accurate and efficient response to customer requests. For example, FIG. 5 illustrates a method that might be performed by some or all of the elements of the system 400 described with respect to FIG. 4 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 510, the system may receive an electronic record associated with a request 510. The electronic record might be associated with, for example, an email message, a text message, a voice channel request that has been translated into text, a fax, a video request, a web site submission, a mobile application, a messaging application, etc.

At 520, an artificial intelligence orchestration platform may automatically determine an intent of the request associated with the electronic record. For example, the artificial intelligence platform might communicate with a classification platform service and/or analyze the electronic record to determine the intent. Based on an indication of intent, at 530 an entity extraction platform an entity extraction platform may extract at least one requisite entity identifier from the electronic record in accordance with a transaction requirement. According to some embodiments, the entity extraction platform is coupled to a domain lexicon specific to intent type. Moreover, the entity extraction platform may access e-forms, scanned forms, online web forms, etc. for data extraction on intent type element extractions.

At 540, a robotic automation platform may process the request utilizing the indication of intent and the extracted requisite entity identifier. For example, the robotic automation platform may process the request by automatically transmitting a complete response to the request. In other cases, the robotic automation platform may process the request by automatically pre-populating data in a template provided to a human knowledge worker. In still other cases, the robotic automation platform may process the request by automatically determining additional information associated with the request (e.g., by asking an originator of the request for the additional information or receiving the additional information from a third-party device). Note that the robotic automation platform may interacts with downstream systems through Application Programming Interface (“API”) and/or front end Robotic Processing Automation (“RPA”) to transact customer requests.

According to some embodiments, the system may further include an intent library storing, for each of a plurality of customers of an enterprise, historic customer request and intent definition information. Moreover, embodiments might include an artificial intelligence customer service terminal to facilitate interactions with a customer and/or a parsing platform to decompose large Binary Large Object (“blob”) text into smaller sentence structures for finite intent understanding and handling multiple intent requests within a single blob of text.

According to some embodiments, a supervised learning platform may be provided for low confidence transactions to facilitate model training and ongoing systematic model enhancements. Similarly, an unsupervised learning platform might be provided for low confidence transactions to facilitate model training and ongoing systematic model enhancements to systematically leverage knowledge worker request processing. Moreover, an analytics platform might identify type I and type II errors in classification, maintain statistics on historic decisions, and/or generate final decision processing logs.

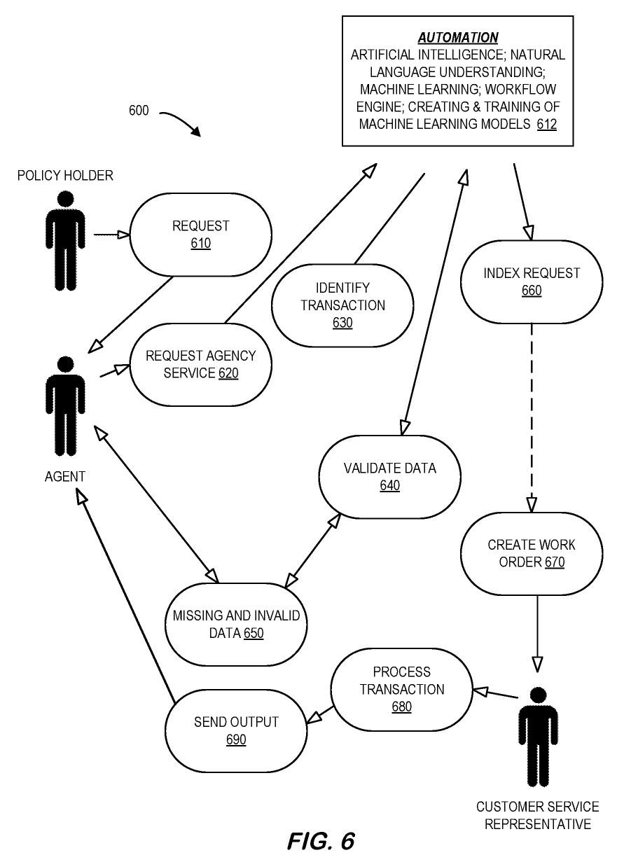

FIG. 6 is a use case 600 for processing requests for certificates of insurance in accordance with some embodiments. As in FIG. 2, a policy holder or agent might generate a request 610 and/or request agency service 620. In this case, however, an automation 612 may respond to the request by identifying a type of transaction 630 and determining if a validate data 640 process indicates that missing or invalid data 650 needs to be supplied or corrected. The automation 612 can then index the request 660 to invoke a work order 670. The automation 612 or a customer service representative may the process the transaction 680 and invoke a send output 690 process to complete the request. Note that automation 612 might utilize artificial intelligence, NLU, machine learning, a workflow engine, create and train machine learning models, etc.

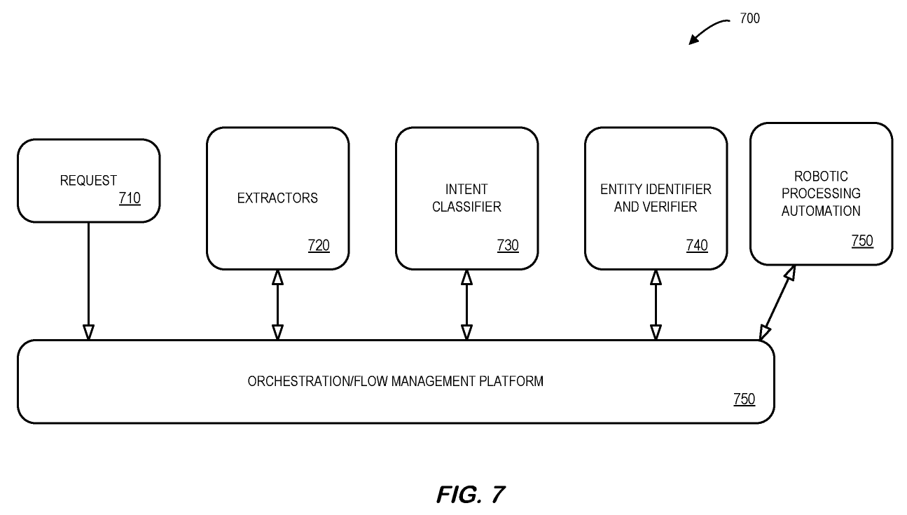

FIG. 7 is a solution context 700 that might be implemented according to some embodiments. In particular, an orchestration/flow management platform 750 may act as a coordinator. A request 710, such as a translated voice request, email, Simple Messaging System (“SMS”) text, facsimile, etc. may be processed by one or more extractors 720. The extractors 720 might use, for example, Optical Character Recognition (“OCR”), image analysis, etc. to access the content of an email, attachments, etc. An intent classifier 730 may analyze the extracted data and output intent, sentiment, and/or confidence values. An entity identifier and verifier 740 may locate insurance policy details, agency information, a certificate holder identifier, etc. that can be used by a Robotic Processing Automation (“RPA”) 750 to respond to the request 710.

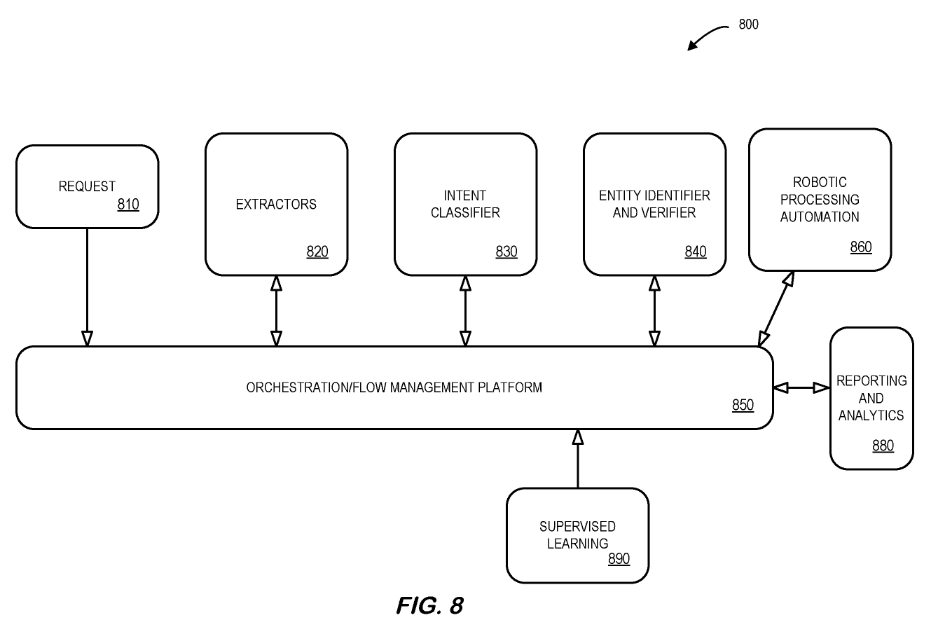

FIG. 8 is a solution context 800 with expanded applicability in accordance with some embodiments. As in FIG. 7, an orchestration/flow management platform 850 may act as a coordinator. A request 810, such as a translated voice request, email, SMS text, facsimile, video stream, Instant Message (“IM”), etc. may be processed by one or more extractors 820. The extractors 820 might use, for example, OCR, image analysis, live camera streams, handwritten notes, etc. to access the content of an email, attachments, etc. An intent classifier 830 may analyze the extracted data (including unstructured or freeform data, structured or pre-defined text, images, conversations and chats, etc. and output intent, sentiment, and/or confidence values. An entity identifier and verifier 840 may locate insurance policy details, agency information, a certificate holder identifier, etc. that can be used by a RPA 860 (including multiple bots and other systems working together) to respond to the request 810. In this embodiment, reporting and analytics 880 may create training data and run-time performance statistics associated with machine learning models. For example, supervised learning 890 may provide low confidence classification and entity extractions across various lines of business, support pre-training analytics, provide post-training metrics, etc.

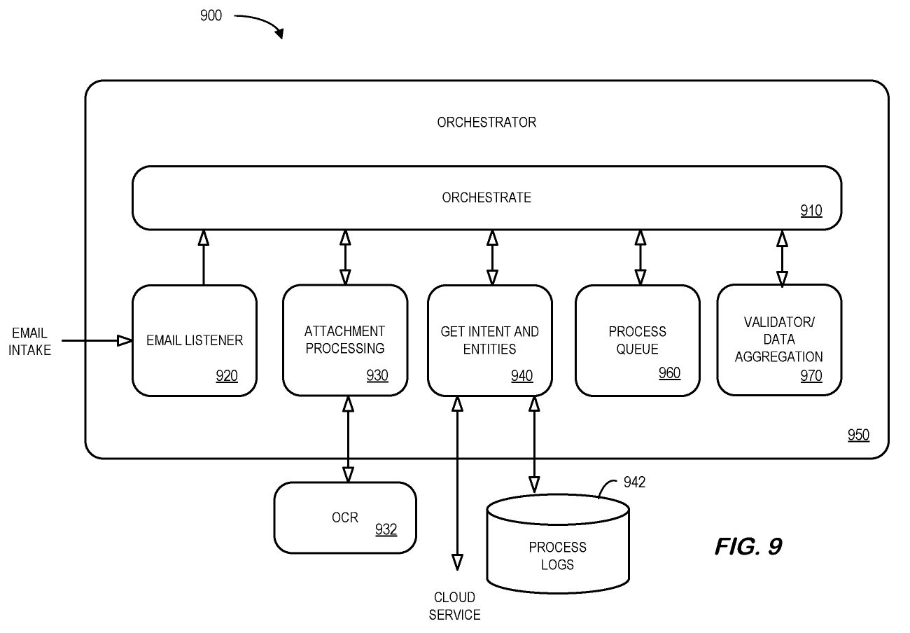

FIG. 9 is a run-time implementation 900 of an end-to-end approach according to some embodiments. An orchestrator 950 and orchestrate process 910 may manage necessary service calls for intake data, categorization, and/or entity extraction processes. An email listener 920 may receive email intake and attachment processing 930 may use OCR 932 capability exposed as a service to retrieve data from pdf files. Note that the attachment processing 930 may use other technologies to handle other attachment types. Get intent and entities 940 might utilize cloud services and/or process logs 942 to implement rules and configuration data and an NLP engine with machine learning capabilities may be trained to classify emails and to extract data entities from unstructured content. A process queue 960 and validator/data aggregation 970 may generate output that requires manual intervention using rules to interpret confidence scores, data completeness, back end validation algorithms, etc.

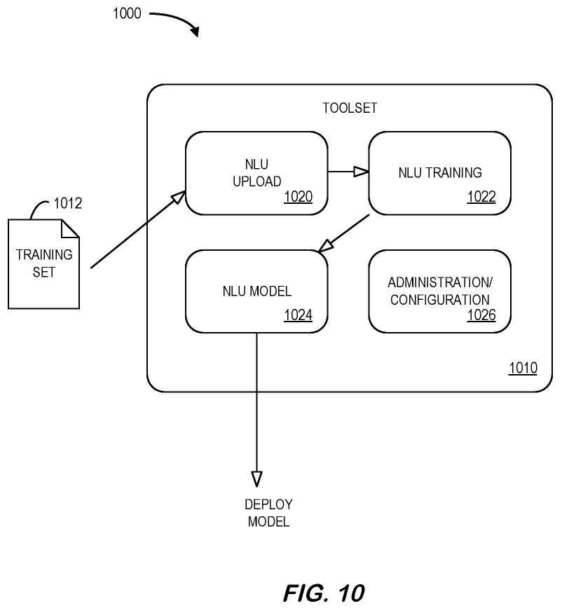

FIG. 10 is a design-time implementation 1000 of an end-to-end approach according to some embodiments. A training set 1012 may be uploaded to a toolset 1010. In particular, an NLU upload 1020 may receive the training set 1012 and implement NLU training 1022 to create a NLU model 1024. According to some embodiments, administration/configuration 1026 parameters may be used to customize the NLU model 1024. The NLU model 1024 may be transmitted to be deployed by an enterprise.

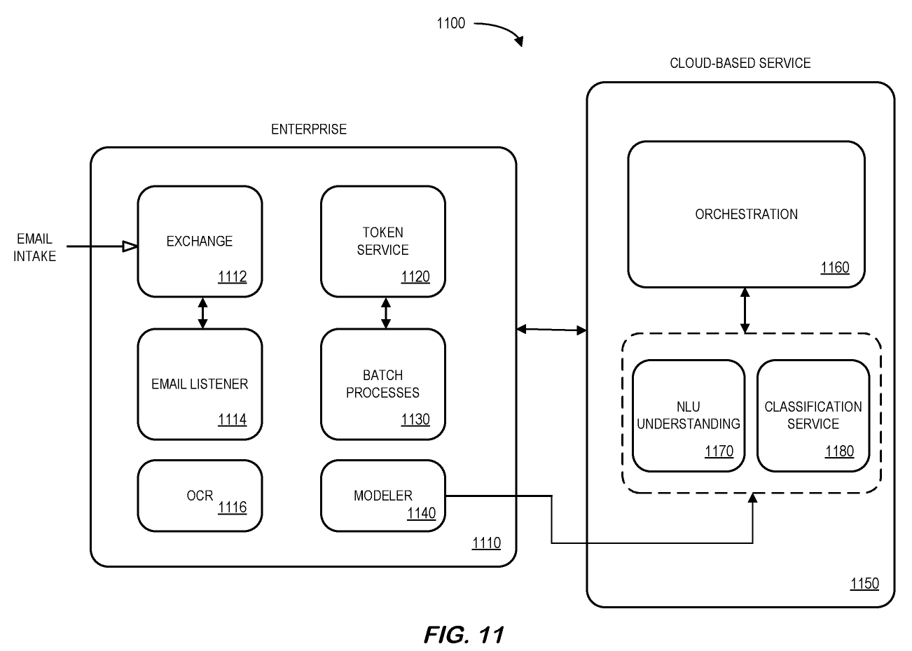

FIG. 11 is high level overview of an end-to-end design 1100 in accordance with some embodiments. The design 1100 includes both enterprise elements 1110 and cloud-based service elements 1150. The enterprise elements 1110 might include an exchange 1112 to receive email intake to be processed by an email listener 1114 and OCR 1116. Batch processes 1130 and a token service 1120 may be used to provide information to the cloud-based service 1150 as appropriate. The cloud-based service 1150 might include orchestration 1160, NLU understanding 1170 and a classification service 1180 as implemented via a modeler 1140 of the enterprise 1110.

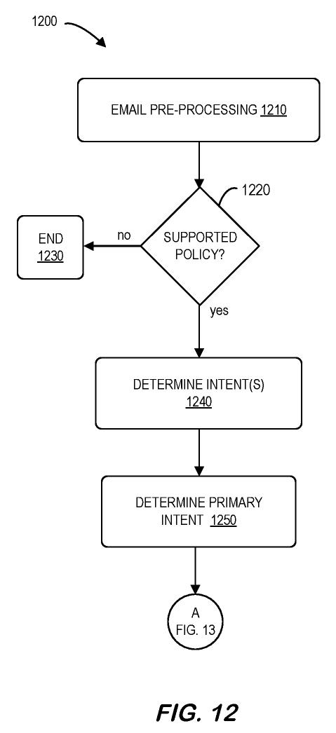

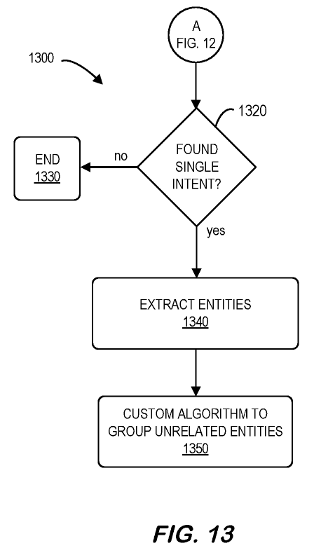

FIGS. 12 and 13 are orchestration workflow methods 1200, 1300 according to some embodiments. At 1210, email pre-processing may be performed to trim and clean the data (e.g., to remove unnecessary information). If the email is not associated with a supported policy at 1220, the process ends at 1230 (e.g., and an administrator might investigate why a request connected with an unsupported policy as received by the system). If the email is associated with a supported policy at 1220, the system determines one or more intents at 1240. Moreover, the system may attempt to identify one of those intents as a “primary” intent at 1250 (e.g., the main reason why the customer or agent sent the email). If a single intent cannot be found at 1320, the process ends at 1330 (e.g., and manually review might be required to figure out what the customer really wants). If a single intent can be determined at 1320, relevant entities may be extracted at 1340 (e.g., a name and address associated with a COI). According to some embodiments, a customer algorithm may group unrelated entities as appropriate at 1350.

Thus, embodiments may provide a “straight through” processing engine that is able to take in different types of transactions, determine what data to extract and how to extract it, determine how to route the information, extract appropriate data, and route a structured work order to a robot for automatic processing. Moreover, embodiments may provide an ability to plug and play “data extraction” technologies including: (i) an engine with workflow capabilities that knows what to do with each transaction, and (ii) an engine that passes classified transactions, with data extracted, to a robot to complete the request. Use might include, for example: email service requests (such as request for a COI), (ii) processing of claims with photographs of damage, and (iii) processing of claims with video of damage. The architecture described herein may enable addition of whatever technology is needed to do data extraction and classification. Moreover, embodiments may enable any combination of these technologies to be applied to a transaction to achieve the needed level of data extraction and classification.

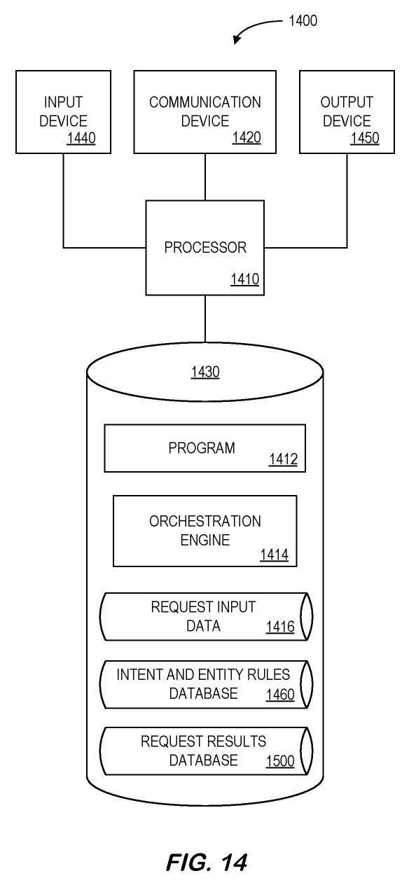

The embodiments described herein may be implemented using any number of different hardware configurations. For example, FIG. 14 illustrates a platform or apparatus 1400 that may be, for example, associated with the system 400 of FIG. 4. The apparatus 1400 comprises a processor 1410, such as one or more commercially available Central Processing Units (“CPUs”) in the form of one-chip microprocessors, coupled to a communication device 1420 configured to communicate via a communication network (not shown in FIG. 14). The communication device 1420 may be used to communicate, for example, with one or more text sources and/or insurance applications. The apparatus 1400 further includes an input device 1440 (e.g., a mouse and/or keyboard to define NLP rules) and an output device 1450 (e.g., a computer monitor to display reports and request processing results).

The processor 1410 also communicates with a storage device 1430. The storage device 1430 may comprise any appropriate information storage device, including combinations of magnetic storage devices (e.g., a hard disk drive), optical storage devices, mobile telephones, and/or semiconductor memory devices. The storage device 1430 stores a program 1412 and/or an orchestration engine 1414 for controlling the processor 1410. The processor 1410 performs instructions of the programs 1412, 1414, and thereby operates in accordance with any of the embodiments described herein. For example, the processor 1410 may automatically determine an intent of an electronic record (e.g., an email message, text, translated voice channel request, etc.) associated with a request (e.g., by communicating with a classification platform service or analyzing the electronic record). Based on an indication of intent, the processor 1410 may extract at least one requisite entity identifier from the electronic record in accordance with a transaction requirement. The processor 1410 may then arrange for a robotic automation platform to process the request utilizing the indication of intent and the extracted requisite entity identifier. For example, the robotic automation platform may transmit a complete response to the request, pre-populate data in a template provided to a human knowledge worker, determine additional information associated with the request, etc.

The programs 1412, 1414 may be stored in a compressed, uncompiled and/or encrypted format. The programs 1412, 1414 may furthermore include other program elements, such as an operating system, a database management system, and/or device drivers used by the processor 1410 to interface with peripheral devices.

As used herein, information may be “received” by or “transmitted” to, for example: (i) the apparatus 1400 from another device; or (ii) a software application or module within the text mining apparatus 1400 from another software application, module, or any other source.

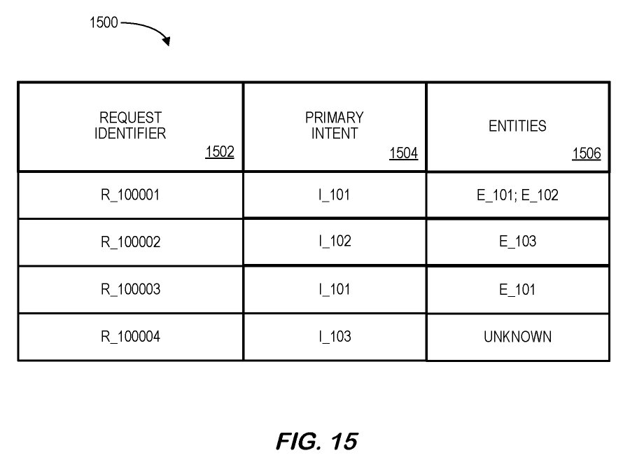

In some embodiments (such as shown in FIG. 14), the storage device 1430 further stores request input data 1416 (e.g., email text), an intent and entity extraction rules database 1460, and a request results database 1500. An example of a database that may be used in connection with the apparatus 1400 will now be described in detail with respect to FIG. 15. Note that the database described herein is only one example, and additional and/or different information may be stored therein. Moreover, various databases might be split or combined in accordance with any of the embodiments described herein.

Referring to FIG. 15, a table is shown that represents the request results database 1500 that may be stored at the apparatus 1400 according to some embodiments. The table may include, for example, entries identifying customer requests that have been received and processed by an enterprise. The table may also define fields 1502, 1504, 1506 for each of the entries. The fields 1502, 1504, 1506 may, according to some embodiments, specify: a request identifier 1502, a primary intent 1504, and one or more entities 1506 for each request. The request results database 1500 may be created and updated, for example, based on information received from customers, cloud-based services, etc.

The request identifier 1502 may be, for example, a unique alphanumeric code identifying a request received from a customer (e.g., an email, text message, facsimile, etc.). The primary intent 1504 might be automatically generated using NLC and/or NLP technologies. The entities 1506 might be one or more identifiers (e.g., names, addresses, etc.) that were automatically extracted from text associated with the request identifier 1502.

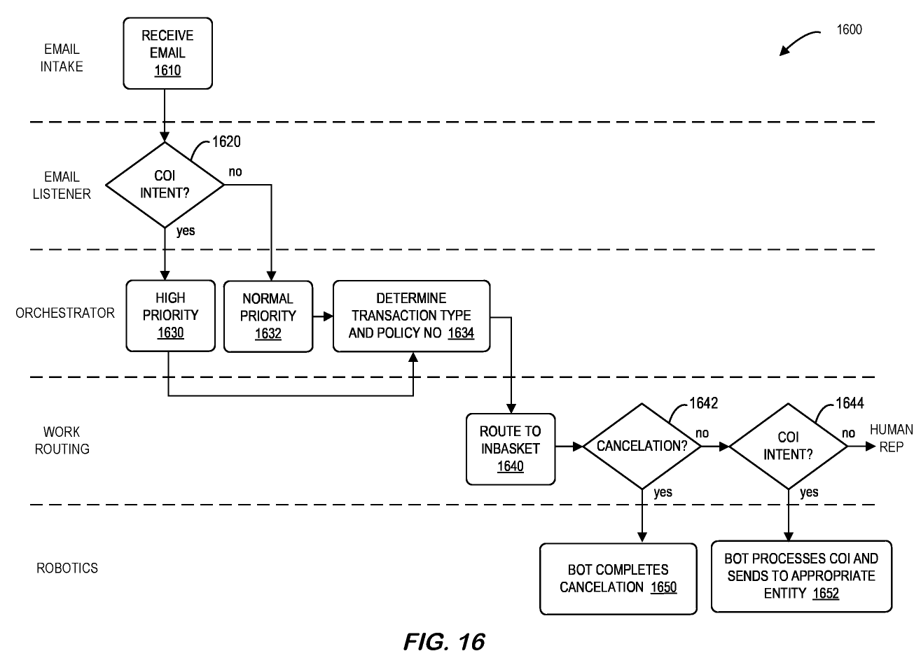

FIG. 16 is a high-level process flow 1600 according to some embodiments. The flow 1600 begins at 1610 with an email received by an email intake process. An email listener determines if the email is associated with a COI intent at 1620. If the email is associated with a COI intent at 1620, an orchestrator assigns it a “high” priority at 1630. If the email is not associated with a COI intent at 1620, the orchestrator assigns it a “normal” priority at 1632. In either case, the transaction type and insurance policy number are determined at 1634.

A work routing process routes the request to an in-basket at 1640. If the request is associated with a cancelation at 1642, a robotic automation completes the cancelation at 1650. If the request is associated with a COI at 1644, a robotic automation sends the COI to an appropriate entity at 1652. If the request was associated with a cancelation or COI, it may be routed to a human representative for manual processing.

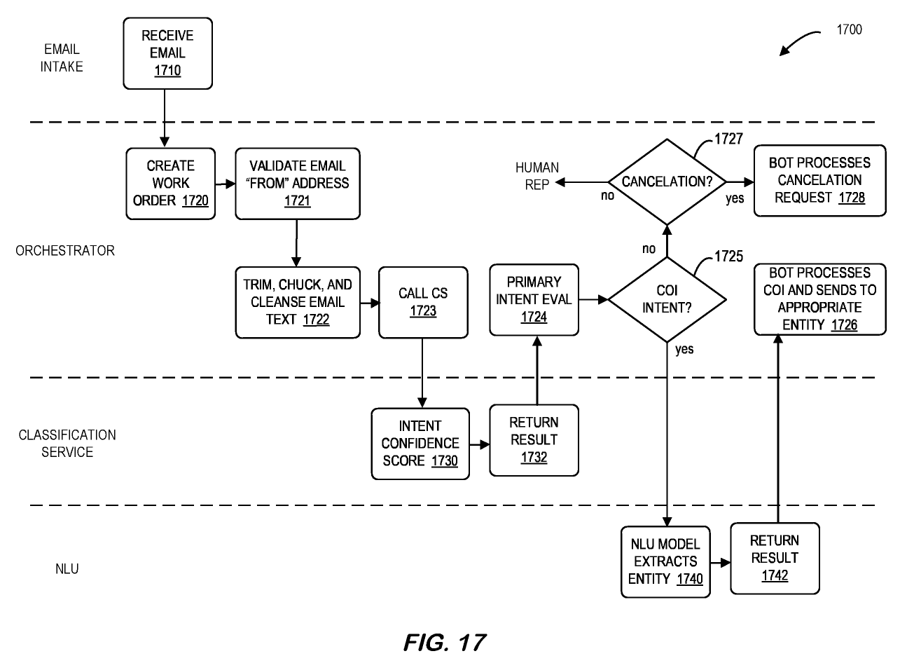

FIG. 17 is another high-level process flow 1700 in accordance with some embodiments. Email intake receives an email at 1710, and orchestrator creates a work order at 1720. The orchestrator may validate the email address at 1721, and trim, chuck, and cleanse the email text at 1722. A Classification Service (“CS”) is called at 1723 and, as a result, the CS determines an intent confidence score at 1730 and returns the result at 1732. If a primary intent evaluation at 1724 indicates a COI intent at 1725, an NLU model extracts one or more entities at 1740 and returns the result at 1742 so that a bot can process the COI and send it to an appropriate entity at 1726. If the primary intent evaluation at 1724 indicates a cancelation intent at 1727, a bot can process the cancelation request at 1728. If the primary intent evaluation at 1724 indicates neither a COI nor cancelation, the request may be forwarded to a human representative for manual processing.

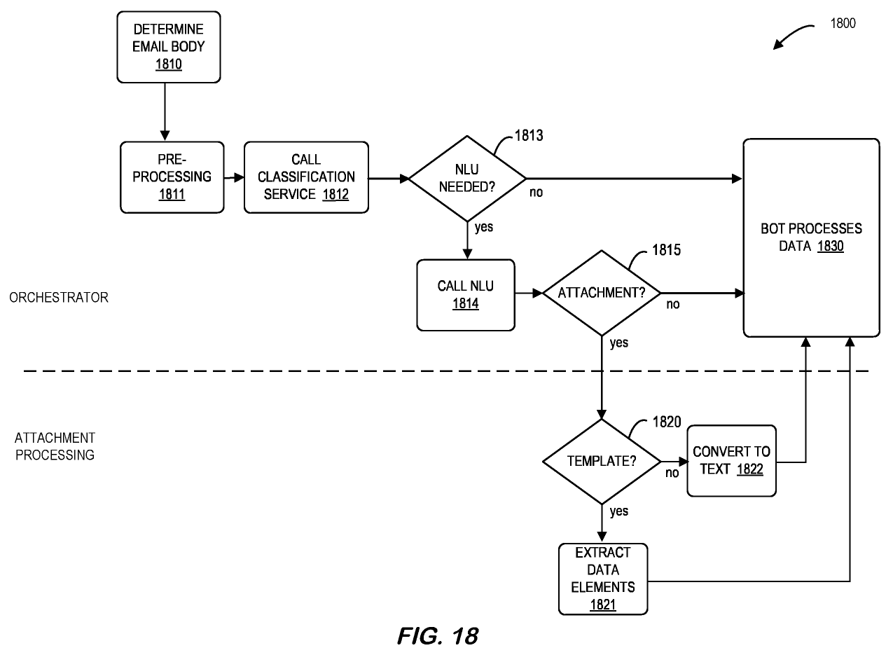

Note that a request might include one or more attachments (e.g., files) in addition to email text. FIG. 18 illustrates attachment processing 1800 according to some embodiments. At 1810, an orchestrator determines an email body and performs pre-processing at 1811. The orchestrator calls a classification service at 1812 and determines if NLU is required at 1813. IF NLU is not needed at 1813, a bot processes the available data at 1830. If NLU is called at 1814, it is determined if an attachment exists at 1815. If no attachment exists at 1815, the bot processes the available data at 1830. If there is an attachment at 1815, a template may be identified at 1820 and used to extract data elements 1821 (e.g., it might be known that a certain location on a particular pdf form always contains an insured address). If no template is identified at 1820, the attachment processing may simply convert the attachment to text at 1822. In either case, the bot may then process the available data at 1830 to automatically respond to the request.

Thus, embodiments may provide a system and method for email and text processing using artificial intelligence and domain lexicon. Moreover, embodiments might read emails (including SMS text and transcribed speech), interpret intents, extract element content, and/or fully process customer transactions with limited human intervention at run-time. Note that embodiments may leverage NLP, container and application orchestration, and RPA tools to integrate disparate technologies as a suite in pursuit of automating unstructured requests through various channels. Some embodiments may utilize third party data science and orchestration services. Moreover, model accuracy may be assessed using blind production emails within a test suite.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

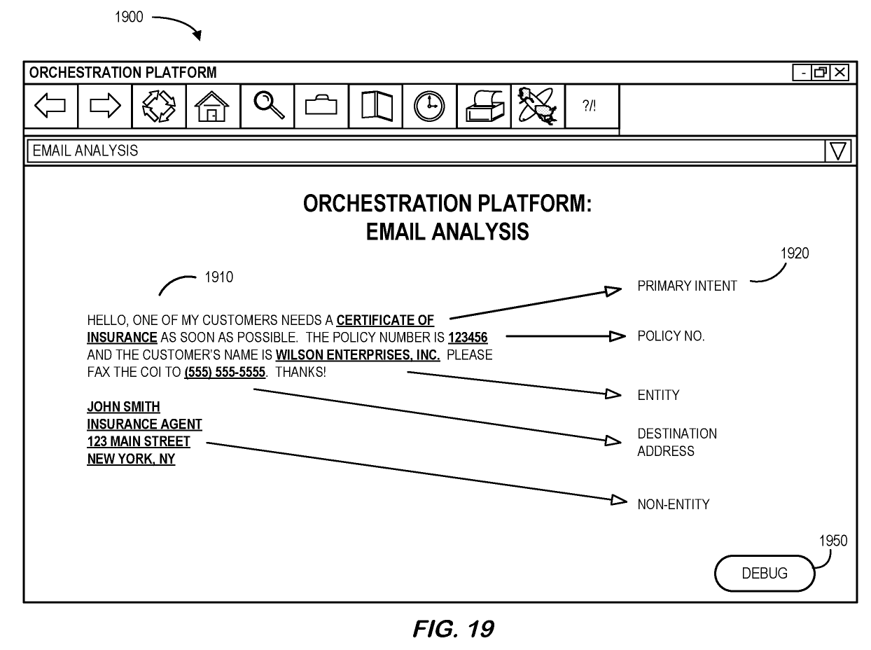

Note that information might be provided to customers and/or administrators in any number of different ways. For example, FIG. 19 illustrates a display 1900 in accordance with some embodiments. The display 1900 email text 1910 that was automatically analyzed. Moreover, the display 1900 indicates which text portions were mapped to various data elements 1920. For example, “Certificate of Insurance” was mapped to primary intent, “Wilson Enterprises, Inc.” was mapped to an extracted entity, etc. An administrator might review the display 1900 and select a “Debug” icon to see when certain mappings were made (and perhaps correct a problem in the logic).

Applicants have discovered that embodiments described herein may be particularly useful in connection with particular types of insurance policies and associated claims. Note, however, that other types of business and insurance data may also benefit from the invention. For example, embodiments of the present invention may be used in connection with automobile insurance policies, financial services, government functions, etc.

Moreover, it is also contemplated that embodiments may process recommendations in one or more languages, such English, French, Arabic, Spanish, Chinese, German, Japanese and the like. In an exemplary embodiment, a system can be employed for sophisticated text analyses, wherein text can be recognized irrespective of the text language. The relationships between the various words/phrases can be clarified by using a rules engine for classifying words/phrases as a predictor of intent or entity.

According to some embodiments, text data may be used in conjunction with one or more predictive models to take into account a large number of intent, entity, and/or other parameters. The predictive model(s), in various implementation, may include one or more of neural networks, Bayesian networks (such as Hidden Markov models), expert systems, decision trees, collections of decision trees, support vector machines, or other systems known in the art for addressing problems with large numbers of variables. Preferably, the predictive model(s) are trained on prior text data and outcomes known to the insurance company. The specific text data and outcomes analyzed may vary depending on the desired functionality of the particular predictive model. The particular text data parameters selected for analysis in the training process may be determined by using regression analysis and/or other statistical techniques known in the art for identifying relevant variables and associated weighting factors in multivariable systems. The parameters can be selected from any of the structured data parameters stored in the present system, whether the parameters were input into the system originally in a structured format or whether they were extracted from previously unstructured text, such as from big data.

Some embodiments have been described herein with respect to COI and cancelation request. Note, however, that any embodiments might also be applicable to, for example, Automobile Liability (“AL”) and/or General Liability (“GL”) insurance scenarios. For example, a lack of structured data may present challenges (such as when medical bills are not paid directly by an insurance enterprise or demand packages take years from an original Date Of Loss (“DOL”)).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system for processing a request associated with an electronic record, comprising:
an artificial intelligence orchestration platform, including:
an artificial intelligence orchestration communication device to receive electronic record,
an artificial intelligence orchestration processor coupled to the artificial intelligence orchestration communication device, and
an artificial intelligence orchestration storage device in communication with said artificial intelligence orchestration processor and storing instructions adapted to be executed by said artificial intelligence orchestration processor to:
(i) automatically determine an intent associated with the request, and
(ii) transmit an indication associated with intent;
an entity extraction platform coupled to the artificial intelligence orchestration platform, including:
an entity extraction communication device to receive the indication of intent transmitted by the artificial intelligence orchestration platform,
an entity extraction processor coupled to the entity extraction communication device,
an entity extraction storage device in communication with said entity extraction processor and storing instructions adapted to be executed by said entity extraction processor to:
(i) based on the indication of intent, extract at least one requisite entity identifier from the electronic record in accordance with a transaction requirement; and
a robotic automation platform to process the request utilizing the indication of intent and the extracted requisite entity identifier.

2. The system of claim 1, wherein said automatic determination of the intent associated with the request comprises at least one of: (i) communicating with a classification platform service, and (ii) analyzing the electronic record to determine the intent associated with the request.

3. The system of claim 1, wherein the electronic record is associated with at least one of: (i) an email message, (ii) a text message, (iii) a voice channel request that has been translated into text, (iv) a fax, (v) a video request, (vi) a web site submission, (vii) a mobile application, and (viii) a messaging application.

4. The system of claim 1, wherein the robotic automation platform processes the request by automatically transmitting a complete response to the request.

5. The system of claim 1, wherein the robotic automation platform processes the request by automatically pre-populating data in a template provided to a human knowledge worker.

6. The system of claim 1, wherein the robotic automation platform processes the request by automatically determining additional information associated with the request.

7. The system of claim 6, wherein said determining is associated with at least one of: (i) asking an originator of the request for the additional information, and (ii) receiving the additional information from a third-party device.

8. The system of claim 1, further comprising:
an intent library storing, for each of a plurality of customers of an enterprise, historic customer request and intent definition information.

9. The system of claim 1, further comprising:
an artificial intelligence customer service terminal to facilitate interactions with a customer.

10. The system of claim 1, further comprising:
a parsing platform to decompose large blob text into smaller sentence structures for finite intent understanding and handling multiple intent requests within one blob of text

11. The system of claim 1, wherein the entity extraction platform is coupled to a domain lexicon specific to intent type.

12. The system of claim 1, wherein the entity extraction platform accesses at least one of: (i) e-forms, (ii) scanned forms, and (iii) online web forms for data extraction on intent type element extractions.

13. The system of claim 1, further comprising:
a supervised learning platform for low confidence transactions to facilitate model training and ongoing systematic model enhancements.

14. The system of claim 1, further comprising:
an unsupervised learning platform for low confidence transactions to facilitate model training and ongoing systematic model enhancements to systematically leverage knowledge worker request processing.

15. The system of claim 1, further comprising:
an analytics platform to identify type I and type II errors in classification, maintain statistics on historic decisions, and generate final decision processing logs.

16. The system of claim 1, wherein the robotic automation platform interacts with downstream systems through Application Programming Interface (“API”) and/or front end Robotic Processing Automation (“RPA”) to transact customer requests.

17. A computer-implemented method for processing a request associated with an electronic record, comprising:
automatically determining, by an artificial intelligence orchestration platform, an intent of the electronic record associated with the request;
based on an indication of intent, extracting, by an entity extraction platform, at least one requisite entity identifier from the electronic record in accordance with a transaction requirement; and
processing the request, by a robotic automation platform, utilizing the indication of intent and the extracted requisite entity identifier.

18. The method of claim 17, wherein the electronic record is associated with at least one of: (i) an email message, (ii) a text message, (iii) a voice channel request that has been translated into text, (iv) a fax, (v) a video request, (vi) a web site submission, (vii) a mobile application, and (viii) a messaging application.

19. The method of claim 17, wherein the robotic automation platform processes the request by automatically transmitting a complete response to the request.

20. A non-transitory computer-readable medium storing instructions adapted to be executed by a computer processor to perform a method for processing a request associated with an electronic record, said method comprising:
automatically determining, by an artificial intelligence orchestration platform, an intent of the electronic record associated with the request;
based on an indication of intent, extracting, by an entity extraction platform, at least one requisite entity identifier from the electronic record in accordance with a transaction requirement; and
processing the request, by a robotic automation platform, utilizing the indication of intent and the extracted requisite entity identifier.

21. The medium of claim 20, wherein the robotic automation platform processes the request by: (i) automatically pre-populating data in a template provided to a human knowledge worker, or (ii) automatically determining additional information associated with the request.
